(19) United States
(12) Patent Application Publication
(10) Pub. No.: US 2004/0255455 A1
(43) Pub. Date: Dec. 23, 2004

(54) Apparatus and method for positioning back-up pins for supporting substrate

(76) Inventors: Won-keun Yu, Pyongtaek-city (KR); Yun-hyuk Son, Pyongtaek-city (KR); Jae-jin Lee, Changwon-si (KR)

Correspondence Address: ST. ONGE STEWARD JOHNSTON & REENS, LLC, 986 BEDFORD STREET, STAMFORD, CT, 06905-5619, US

(21) Appl. No.: 10/780,414

(22) Filed: Feb. 17, 2004

(30) Foreign Application Priority Data
Jun. 21, 2003 (KR) 2003-40477

(51) Int. Cl. H02H 3/22; B23P 19/00

(52) U.S. Cl. 29/837; 29/833; 29/760; 29/739

(57) ABSTRACT

An apparatus and method for allocating and positioning back-up pins for supporting a substrate are provided. The apparatus includes a substrate guide rail for guiding a circuit board to a predetermined position; a plurality of magnetic back-up pins for supporting the circuit board; a back-up pin plate for placing the back-up pins thereon; a back-up pin stand disposed near the back-up pin plate and for holding the back-up pins; a camera for photographing an image of a surface of the circuit board; a display means for displaying a virtual or composed image of the entire circuit board scanned by the camera and a real-time image of a portion of the circuit board for aiding a user to allocate the adequate support locations of the circuit board; and a transfer means for transferring the back-up pins onto the allocated locations on the back-up pin plate.

### CROSS-REFERENCE TO RELATED APPLICATIONS

This application claims the priority of Korean Patent Application No. 2003-40477, filed on Jun. 21, 2003, in the Korean Intellectual Property Office, the disclosure of which is incorporated herein by reference.

### BACKGROUND OF THE INVENTION

1. Field of the Invention

The present invention relates to an apparatus and method for positioning back-up pins for supporting a circuit board thereon, and more particularly, to an apparatus and method for allocating and positioning back-up pins on a support plate for supporting a circuit board substrate thereon prior to application of adhesives onto a the circuit board.

2. Description of the Related Art

In a chip mounting process, adhesives, for example, cream solder is typically applied onto a printed circuit board using a screen printer before parts or chips are mounted onto the circuit board. For applying adhesives adequately onto the board substrate using the screen printer, the substrate needs to be supported by an appropriate means in order to prevent it from bending caused by a pressure from a squeegee pushing a printing mask of the screen printer. A printed circuit board (PCB) having a thickness of about 0.5-2 mm may be bent by a pressure applied by the squeegee, which impedes an accurate application of the adhesives (e.g., cream solder). Therefore, a means for preventing bending of the substrate is typically required for application of the adhesives. To prevent a substrate from being bent, several apparatus and methods are known in the art.

One type of known method for supporting a substrate utilizes back-up pins used during the screen printing processes. According to this type of apparatus and methods, a bottom surface of a substrate is supported using a plurality of pins so as to prevent bending of the substrate. Another known method for supporting a substrate utilizes back-up jigs, particularly in case when the substrate is difficult to be supported using back-up pins. For example, this method is applicable when the substrate is a high-density two-sided substrate. Another known method for supporting a substrate utilizes a carrier, particularly in case when the substrate is a film substrate, which is used while attaching the film substrate to an aluminum plate.

Among the known methods and apparatus mentioned above, the type using back-up pins is inexpensive to produce and simple in its structure, and thus, is widely used. However, this type has a typical problem in that an operator usually needs to set the pins manually when the substrate model is changed. This manual setting takes a large amount of time, and thus, causes a low productivity. In particular, when using a two-sided substrate for mounting parts on both sides of the substrate, the precise locations of each of the parts need to be carefully checked to prevent interference between the parts and the support pins, which makes the setting very difficult.

Apparatus and methods of setting such back-up pins are disclosed, for example, in U.S. Pat. No. 5,218,753 and Japanese Patent Application Publication Nos. H06-169198 and H03-214694, however, they do not satisfactorily overcome the above-described problems.

### SUMMARY OF THE INVENTION

The present invention is generally directed to an apparatus for positioning back-up pins on a support plate for supporting a circuit board substrate thereby.

The present invention is also directed to a method of allocating and positioning back-up pins at predetermined positions of a substrate based on information acquired by scanning a surface of the substrate.

According to an aspect of the present invention, an apparatus for positioning back-up pins on a support plate for supporting a circuit board thereon, comprises: a back-up pin plate having a substantially planar upper surface for positioning back-up pins thereon; a back-up pin stand for placing back-up pins therein; a camera for taking an image of a surface of the circuit board to be supported by a plurality of back-up pins; a control unit configured to display at least one image of the circuit board taken by the camera, the image including a first image representative of a portion of the surface of the circuit board and a second image representative of substantially the entire surface of the circuit board, the control unit further configured to allocate a plurality of support locations for supporting the circuit board while viewing the first image and the second image of the circuit board; and, a transfer member adapted to transfer a plurality of back-up pins from the back-up pin stand to the allocated support locations on the back-up pin plate.

It is preferable that at least a portion of the back-up pin plate comprises a magnetizable material or is formed of steel, and each of the back-up pins includes a magnetic portion for attaching onto the back-up pin plate by a magnetic force between the back-up pin plate and the back-up pin. It is also preferable that the first image is a real-time image taken by the camera and the second image is an image composed of a plurality of the real-time images taken by the camera. The control unit of the apparatus preferably includes a monitor and a user interface for allowing a user to control the allocation of the support locations and positioning of the back-up pins. The camera is preferably coupled with the transfer member for moving together along a Cartesian coordinate.

According to another aspect of the present invention, an apparatus for positioning back-up pins on a support plate for supporting a circuit board thereon, comprises: a plurality of back-up pins each having a magnet portion at least a lower portion thereof; a back-up pin plate formed at least partially with a magnetizable material and including a substantially planar upper surface for positioning the back-up pins thereon; and, a transfer member adapted to transfer a plurality of back-up pins onto support locations on the back-up pin plate for supporting a circuit board thereon. The apparatus may further comprises a back-up pin stand for placing back-up pins therein, a camera for taking an image of a surface of the circuit board to be supported by a plurality of back-up pins, and a control unit configured to display at least one image of the circuit board taken by the camera, the image including a first image representative of substantially the entire surface of the circuit board and a second image representative of a portion of the surface of the circuit board, the control unit further configured to allocate a plurality of support locations for supporting the circuit board while viewing the first image and the second image of the circuit board.

According to another aspect of the present invention, a back-up pin to be placed on a support plate for supporting a circuit board thereon in an electronic part mounting process comprises: a lower portion having a magnetic characteristic and including a planar lower surface; and, an upper portion including a planar upper surface for supporting a substrate thereon. The back-up pin preferably has a generally cylindrical shape and includes a circumferential groove along an intermediate portion thereof. The back-up pins to be used for supporting the circuit board may have different dimensions in their upper ends thereof, for example, about 8 mm diameter, about 2 mm, etc.

According to another aspect of the present invention, a method of positioning back-up pins for supporting a substrate comprises: scanning an image of a surface of a substrate using a camera; displaying a first image representative of a portion of the surface of the substrate and a second image representative of substantially the entire surface of the substrate on a monitor of a control unit; allocating back-up pin support locations using the first and second images displayed on the monitor; and, transferring and positioning a plurality of back-up pins at the allocated locations on a back-up pin plate.

The method may further comprise photographing of an image of back-up pins placed on a back-up pin stand to be performed prior to the transferring of the back-up pins. The first image is preferably a real-time image taken by the camera, and the second image is an image composed of a plurality of the real-time images taken by the camera. The allocation of support locations is preferably performed by selecting the locations by a mouse using the first and second images displayed on the monitor. For instance, the allocation of support locations is performed by selecting the locations by the mouse on the second image while viewing the first image to confirm the support locations are not interfered with any parts disposed on the substrate. The allocation further enables selection of particular back-up pins from a plurality of back-up pins with different sizes or type. The scanning of the image of the substrate may comprise scanning of a marking formed on a top surface of the back-up pins to identify the type or dimension of the respective back-up pin.

### BRIEF DESCRIPTION OF DRAWINGS

The above and other features and advantages of the present invention will become more apparent by describing in detail preferred embodiments thereof with reference to the attached drawings in which:

FIG. 1 is a perspective view illustrating major components of an apparatus for positioning back-up pins on a support plate for supporting a substrate thereon, according to one preferred embodiment of the present invention;

FIG. 2 is an enlarged perspective view of a back-up pin stand according to the embodiment of FIG. 1;

FIG. 3 is an enlarged perspective view of a large-diameter back-up pin according to the embodiment of FIG. 1;

FIG. 4 is an enlarged perspective view of a small-diameter back-up pin according to the embodiment of FIG. 1;

FIG. 5 is a flowchart illustrating one preferred method of allocating and positioning the back-up pins, according to the principles of the present invention; and

FIGS. 6 through 9 illustrate several screen displays of a computer monitor used for monitoring the process and further allocating and positioning the back-up pins, according to one preferred embodiment of the present invention.

### DETAILED DESCRIPTION OF EMBODIMENTS

Hereinafter, preferred embodiments of the present invention will be described in detail with reference to the attached drawings. In the drawings, the same reference numerals denote the same or a similar member.

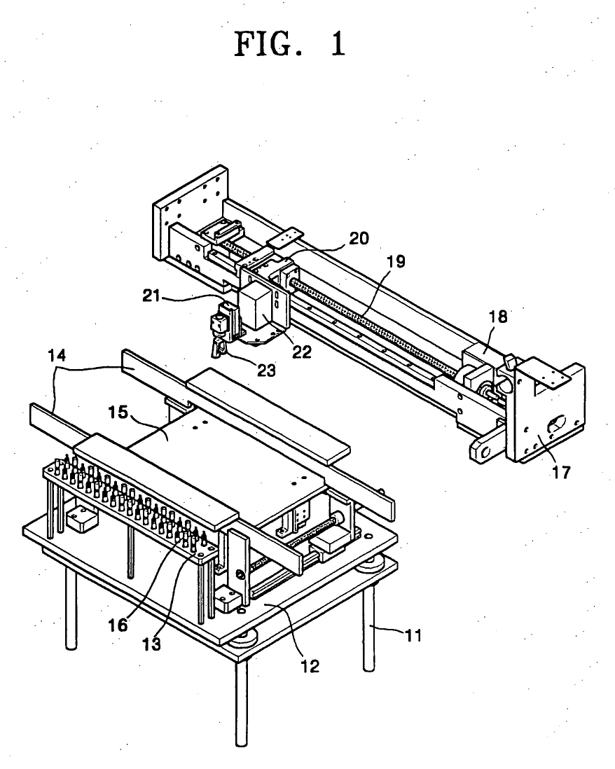

FIG. 1 is a perspective view illustrating major components of the apparatus for positioning back-up pins for supporting a substrate, according to one embodiment of the present invention. This apparatus includes a stage 12 disposed on a base frame 11 for supporting a substrate thereon. The apparatus further includes a back-up pin plate 15 for placing back-up pins 16 on an upper surface thereof, a suitable guide or transfer member such as substrate guide rails 14 for transferring and guiding a printed circuit board (PCB) (not shown) above the back-up pin plate 15, and a back-up pin holding member such as stand 13 which is disposed at one side of the back-up pin plate 15 for holding a plurality of back-up pins 16 in a standing manner. The back-up pin plate 15 has a planar upper surface, and is preferably formed of steel or a magnetizable material. The apparatus of the invention further includes a gripper 23 for gripping a back-up pin 16 and moving between the back-up pin stand 13 and the back-up pin plate 15, and a camera 22 for scanning the image of the back-up pin stand 13 and the PCB. The distance between the two substrate guide rails 14 can be adjusted so that PCBs having different widths can be guided along the substrate guide rails 14.

According to one embodiment of the invention, the gripper 23 and the camera 22 can perform a Cartesian coordinate (i.e., X-Y coordinate) motion on a plane. The gripper 23 can move up and down so that it may grip and release a back-up pin 16 on the back-up pin stand 13 or on the back-up pin plate 15. The gripper 23 and the camera 22 are connected to a nut portion 20 coupled to a ball screw 19 which is rotatable by a drive motor 18, and thus, they can move in a lengthwise direction of the ball screw 19 by rotation of the drive motor 18. The gripper 23 and the camera 22 can also move in a rectilinear direction perpendicular to the lengthwise direction of the ball screw 19 by another linear motion means (not shown) which is configured to move a moving frame 17 of the apparatus to the corresponding direction. A lift cylinder 21 is provided to move the gripper 23 up and down.

A plurality of back-up pins 16 are put on the back-up pin holder or stand 13. A back-up pin 16 can be gripped by the gripper 23 and transferred at a proper location on the back-up pin plate 15 so that it can support a substrate thereon. The back-up pins 16 may be divided into small-diameter back-up pins and large-diameter back-up pins according to a diameter of a surface contacting a bottom surface of the substrate. A plurality of back-up pins 16 having many different diameters may be put on the back-up pin stand 13 so that they can be positioned at appropriate locations on the back-up pin plate 15 in order to meet different designs of the circuit substrate.

The apparatus of the invention preferably includes a computer or control unit (not shown) having a display screen or monitor connected thereto, the computer being coupled with the major components of the apparatus and configured to control the operation the apparatus as will be described herein below.

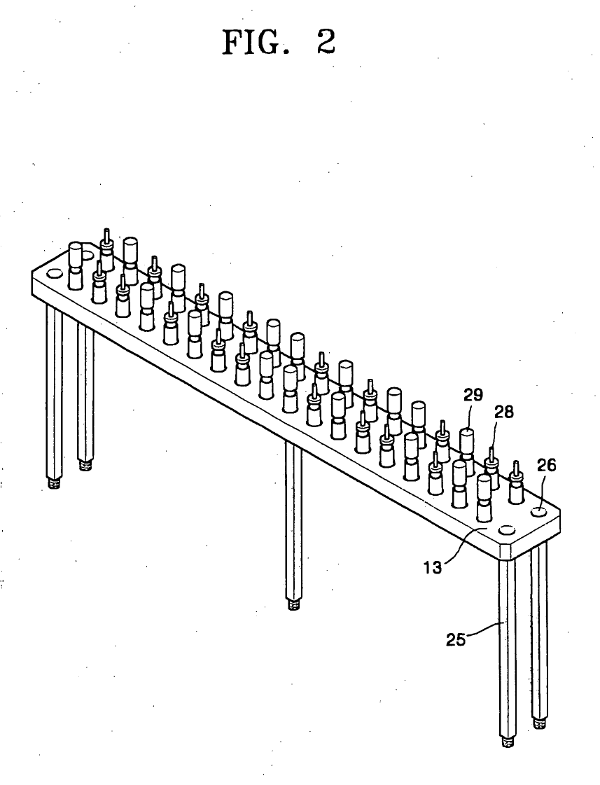

FIG. 2 is an enlarged perspective view illustrating one example of the back-up pin stand according to one embodiment of the present invention. Referring to FIG. 2, the back-up pin stand 13 includes a plurality of legs 25 and a fixing plate disposed thereon for holding a plurality of back-up pins. The fixing plate of the back-up pin stand 13 has a plurality of openings 26 into which back-up pins 28 and 29 are to be inserted so that the back-up pins 28 and 29 can stably stand on the back-up pin stand 13. Back-up pins shown in FIG. 2 include small-diameter back-up pins 28 having a narrow top surface and large-diameter back-up pins 29 having a wide top surface. The back-up pins 28 and 29 having different top surface areas are suitably placed on the support plate 15 to support a substrate at positions where they do not interfere with the parts or chips disposed on the substrate. When a space between the parts is narrow, it is better to use a small-diameter back-up pin 28. When a space between the parts is sufficient, it is better to use a large-diameter back-up pin 29.

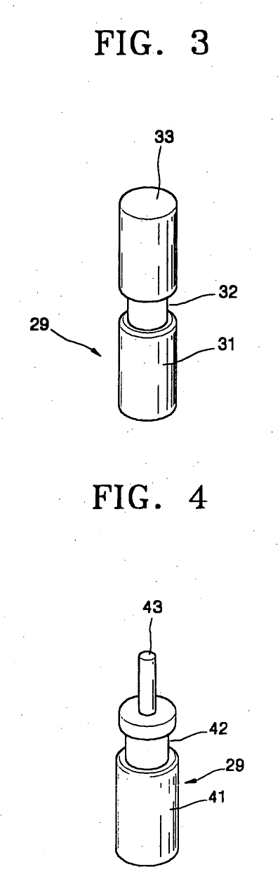

FIG. 3 is an enlarged perspective view of the large-diameter back-up pin 29. Referring to FIG. 3, the large-diameter back-up pin 29 generally has a cylindrical shape, and an upper portion of the large-diameter back-up pin 29 has a diameter of about 8 mm. A circumferential groove 32 is formed at an intermediate location of the large-diameter back-up pin 29. The groove 32 corresponds to gripping contacts of the gripper 23 of FIG. 1 when the gripper 23 grips the large-diameter back-up pin 29. The groove 32 engages the gripping contacts of the gripper 32 so that the large-diameter back-up pin 29 is prevented from escaping from the gripper 23.

A magnet portion 31 is provided at a lower portion of the large-diameter back-up pin 29. The magnet portion 31, for example, may be formed by magnetizing a portion of the large-diameter back-up pin 29 or inserting a magnet into a lower portion of the large-diameter back-up pin 29. Thus, when the large-diameter back-up pin 29 is placed on the back-up pin plate 15, the magnet portion 31 is held by the magnetizable back-up pin plate 15 at a fixed position preventing the back-up pin 29 from moving or falling down.

According to one preferred embodiment of the invention, a marking 33 is disposed on a top surface of the large-diameter back-up pin 29 to allow the camera 22 to identify the type or dimension of the back-up pin during scanning of its image. The marking 33 can also serve to determine, for instance, existence or non-existence of the back-up pin at a particular location, and to check whether the positioning of the back-up pins are in proper locations or alignment upon scanning of image by the camera 22.

FIG. 4 is an enlarged perspective view of the small-diameter back-up pin 29. A circumferential groove 42 is similarly formed at an intermediate location of the small-diameter back-up pin 28 to prevent the small-diameter back-up pin 28 from escaping from the gripper 23 of FIG. 1 when the gripper 23 grips the small-diameter back-up pin 28. The upper portion of the small-diameter back-up pin 28 is smaller than that of the upper portion of the large-diameter back-up pin 29. The upper portion of the small-diameter back-up pin 28 generally has a cylindrical shape with a diameter of about 2 mm. Like the large-diameter back-up pin 29, a marking 43 is formed on a top surface of the small-diameter back-up pin 28, and a magnet portion 41 is provided at a lower portion thereof for the reasons described above.

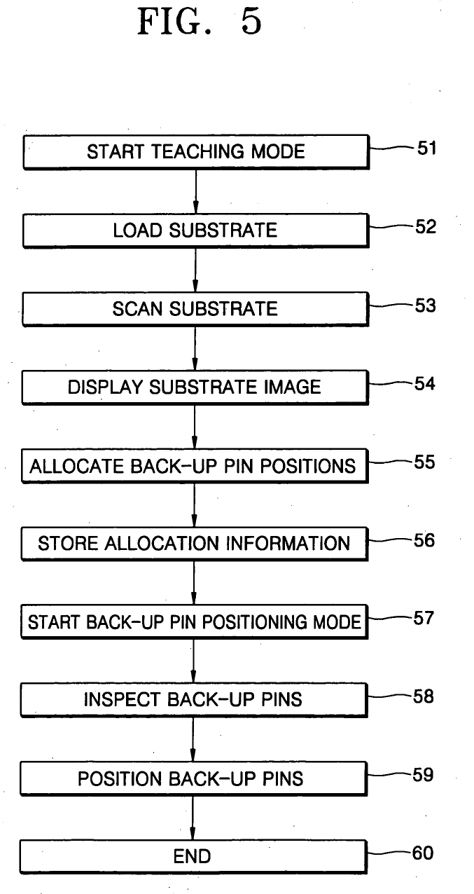

According to one preferred embodiment of the invention, FIG. 5 is a flowchart illustrating allocation of back-up pin support locations and subsequent positioning of the back-up pins for supporting a substrate, preferably using the apparatus of the invention which has been described with reference to FIGS. 1 through 4. Referring to FIG. 5, an instruction or teaching mode is started by the user to determine which positions of a PCB are to be supported using the back-up pins (step 51). In the instruction mode as described herein (i.e., steps 51-56), adequate support locations of the PCB at which parts are not disposed are allocated by the user's selection of suitable support locations after the surface of the PCB is scanned and displayed.

As the user starts the instruction mode, the PCB is loaded at a scan position (step 52). According to the embodiment as shown in FIG. 1, the PCB is conveyed along the substrate guide rails 14 and positioned within a scan area of the camera 22. The camera 22 then scans the surface of the PCB while it moves in a first direction by the ball screw 19 and in a second direction perpendicular to the first direction by an actuating member (not shown) (step 53).

The scanned image is displayed on a display screen (e.g., monitor) of a control unit (not shown) configured to process and control the operations of the apparatus of the invention (step 54). According to one preferred embodiment, the camera 22 is a line charged coupled device (CCD) camera. Because an area which the line CCD camera 22 can scan each time is limited whereas the entire area of the PCB is wider than the area to be scanned by the camera 22 at one time, the camera 22 typically needs to perform a several number of photographing operations so that an image of the entire PCB substrate can be displayed on a screen. More specifically, the size of the substrate is compared with the size of a screen portion on which a scanned image of the complete substrate is displayed, and thereby a reduction ratio is determined. Then, the camera 22 is moved to a first predetermined position above the substrate and scans to photograph an image of a part of the substrate. When the image obtained through the scanning is reduced according to the determined reduction ratio, gray levels of pixels in the image are read. The pixel data are processed so that only a portion of pixels can be drawn on the screen. Next, the camera 22 is moved to a second scan position above the substrate, and the above-described operation is repeated. As the entire substrate is completely scanned, an entire image of the substrate is displayed on the display screen in addition to a real-time display of a part of the substrate taken by the camera (step 54), and the image data is stored as a single file.

After scanning the PCB, a position at which a back-up pin is to be placed is selected (i.e., allocated) by the user as described herein below (step 55). A user views the image of the PCB displayed on a screen of a computer monitor and inputs the position of a back-up pin. The user views a reduced virtual (i.e., composed) image of the PCB and a real-time image of the PCB as discussed, which are displayed on the screen of the computer monitor, and selects a position where a back-up pin does not interfere with parts disposed on the PCB as a back-up pin position.

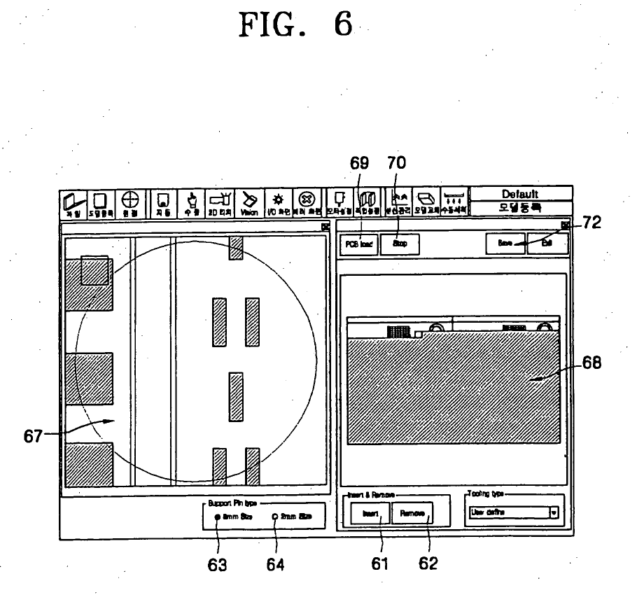

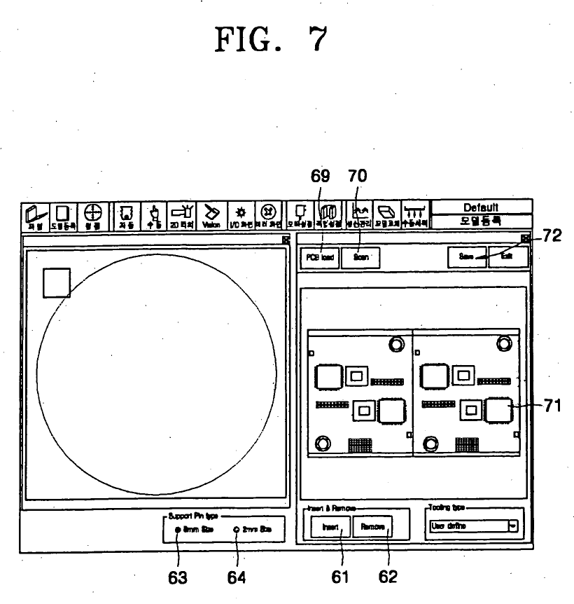

FIGS. 6 through 9 illustrate several screen displays of a computer monitor used for allocation and positioning of the back-up pins according to one preferred embodiment of the invention. A first image (e.g., real-time image) depicting a portion of the PCB taken by the camera 22 is displayed on a left portion 67 of the screen, and a second image (e.g., reduced composed image) depicting the entire PCB is displayed on a right portion 68 of the screen. FIG. 6 shows a state in which only a part of the PCB is scanned. FIG. 7 shows a reduced composed image of a fully scanned PCB, which is denoted by reference numeral 71. When a user moves a mouse pointer to a position on the reduced composed image 71 using a mouse of the computer or control unit, the camera 22 is configured by the computer to move to the same (corresponding) position above the PCB and a real-time image of a portion of the PCB corresponding to the position is displayed on the left screen portion 67. The real-time image displayed on the left portion 67 may be enlarged or reduced by the user selection. Accordingly, the user can monitor a virtual image of the entire PCB on the right portion 68 of the screen and an enlarged (or reduced) real-time image of a particular portion of the PCB on the left portion 67 of the screen.

Functional buttons and modes, which the user can select preferably by clicking thereon with the mouse, are displayed on the screen of the computer monitor shown in FIGS. 6 through 9. For example, the user can load a PCB by clicking on a PCB load button 69. The user can start or stop scanning by clicking on a scan/stop button 70. The user can also save an image of the completely scanned PCB by clicking on a save button 72. Back-up pins of different dimensions (for example, an 8 mm size back-up pin or a 2 mm size back-up pin) can be selected by clicking on a button denoted by reference numeral 63 or 64.

Hereinafter, a procedure of scanning a PCB and disposing a back-up pin is further described with reference to FIGS. 6 through 9.

FIG. 6 shows a state in which the camera 22 started scanning the PCB and has scanned a part of the PCB. A portion of virtual image of the partially scanned PCB is displayed on the right portion 68 of the screen while a real-time image photographed by the camera 22 is displayed on the left portion 67 of the screen.

FIG. 7 shows a state in which the PCB is completely scanned. In other words, reference numeral 71 denotes a virtual image showing the entire PCB in a reduced state.

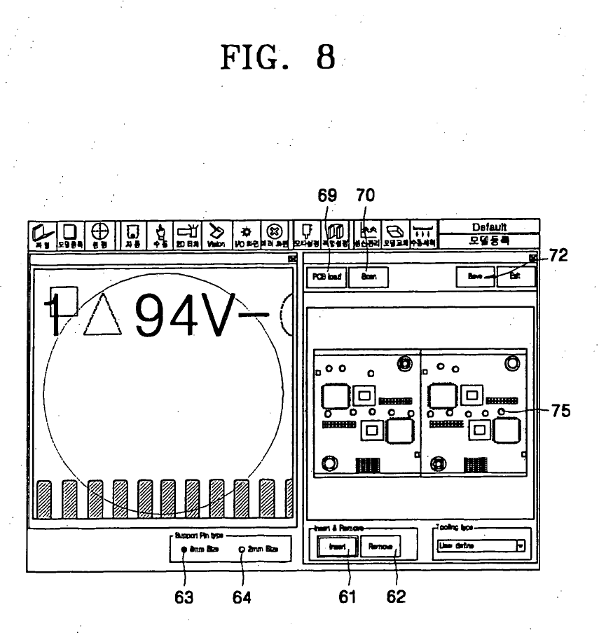

FIG. 8 shows a state in which 8 mm size back-up pins are set (i.e., allocated) on the virtual image of the PCB. Referring to FIG. 8, the user clicks on the button 63 to select an 8 mm size back-up pin and moves a mouse pointer to a suitable position on the virtual image area 71 to set the 8 mm size back-up pin at the selected position. When the mouse pointer is moved on the virtual image area 71, a real-time image depicting a portion of the PCB corresponding to the portion where the mouse pointer is located (on the virtual image 71), is displayed on the left portion 67 of the screen. Accordingly, the user can view the real-time image of the PCB displayed on the left portion 67 and check whether the 8 mm size back-up pin interferes with the parts mounted on the PCB at the particular position before setting the 8 mm size back-up pin at the position.

The user can select a proper position where the 8 mm size back-up pin 75 does not interferes with the parts of the PCB by putting the mouse pointer at the position on the virtual image area 71 and clicking a mouse button, and can further allocate the 8 mm sized back-up pin 75 at the position by clicking an insert button 61 using the mouse.

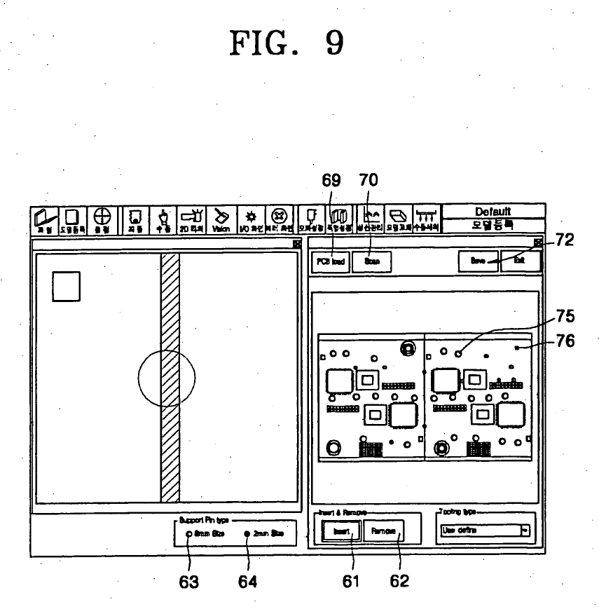

Referring to FIG. 9, the user can click on the button 64 to select a 2 mm size back-up pin. Next, as described above, the user moves the mouse pointer to a position where the 2 mm size back-up pin does not interfere with the parts on the virtual image 71 and clicks the mouse button to select the position. Then, the user clicks on the insert button 61 using the mouse to allocate the 2 mm size back-up pin at the selected position. When a back-up pin is determined to be set in an unsuitable location, the user can cancel the allocation of the back-up pin from the virtual image 71 by clicking on a remove button 62.

After input (i.e., allocation) of back-up pin positions (step 55) is completed through the operations described with reference to FIGS. 6 through 9, the allocation information is stored (step 56). Next, the PCB is removed or discharged from the apparatus. This completes the preparation for positioning back-up pins.

Thereafter, a back-up pin positioning mode is started (step 57). In the back-up pin positioning mode, the camera 22 moves above the back-up pin stand 13 and photographs an image of the back-up pins 16 on the back-up pin stand 13. Upon photographing of the image of the back-up pins 16 by the camera 22, information such as locations of particular back-up pins to be positioned, types and/or dimensions of each of the back-up pins, whether particular back-up pins 16 are placed or not, and false positions of back-up pins 16, are checked and inputted to the computer for controlling the positioning operation (step 58).

Next, each of the selected back-up pins 16 is held by a transfer means (e.g., gripper 23), one by one, and is transferred and positioned at its allocated location on the back-up pin plate 15 (step 59). For transferring a back-up pin 16, the gripper 23 moves to the back-up pin stand 13, moves down, grips the selected back-up pin 16, moves up, moves to the back-up pin plate 15, and places the back-up pin 16 at its allocated location on the back-up pin plate 15. Thus, the back-up pin 16 is placed at a location on the back-up pin plate 15 where it does not interfere with parts of a PCB when it supports the PCB. The location at which the back-up pin 16 is placed corresponds to the location which has been selected through the operations described above with reference to FIGS. 6 through 9. In other words, according to the allocation information stored in the computer through the operations as described, the gripper 23 places each of the small-diameter back-up pins 28 and/or the large-diameter back-up pins 29 at a respective position as planned. When all of the allocated back-up pins 16 are completely positioned, the operation of positioning the back-up pins 16 ends (step 60).

After the operation of positioning back-up pins ends, a PCB of the same specification is transferred and placed at a predetermined location on the back-up pins 16 of the apparatus so that the PCB is suitably supported by the back-up pins, and is subjected to a subsequent process (i.e., a cream solder operation) for mounting electronic parts thereon.

The operation of allocating and positioning of back-up pins described above can be advantageously utilized for two-sided substrates. When a cream solder operation is performed on a first side of a two-sided substrate of which a second side of the substrate has parts previously mounted thereon, it is difficult or at least a tedious job to support the two-sided substrate with back-up pins without interfering with the pre-disposed parts when utilizing the conventional technology known in the art. In the present invention, a user can allocate proper back-up pins at proper locations based on the image information obtained by scanning of the substrate. In particular, the allocation can effectively be performed using a virtual image of the scanned two-sided substrate while viewing the details of the second side of the two-sided substrate in real time, as illustrated and described with reference to FIGS. 5 through 9. As such, the back-up pins are allocated based on information input using a first set of real-time image and a second set of virtual or composite image displayed on the monitor, and they are further guided by the allocation information for the subsequent positioning at suitable locations on a back-up pin plate so that the back-up pins can be placed to support the two-sided substrate without interfering with the parts previously disposed on the two-sided substrate.

When parts are to be mounted on only one side of a substrate, it may not be necessary to scan the other side of the substrate. In this situation, back-up pins can be set on the back-up pin plate according to an optimized positioning configuration. For example, the computer may have information for positioning back-up pins in zigzag pattern or in linearly aligned pattern spaced with a predetermined interval according to the area, type and shape of a substrate. A user can set back-up pins on the back-up pin plate based on such information.

According to the apparatus and method of the invention for allocating and positioning back-up pins for supporting a substrate, since back-up pins can be easily and accurately positioned, productivity can be increased. In addition, since back-up pins can be safely located where they do not interfere with parts on a substrate, the parts will not be damaged.

Although several embodiments of the present invention have been shown and described, it will be appreciated by those skilled in the art that changes may be made in these elements, structures, mechanisms, and methods without departing from the principles and spirit of the invention, the scope of which is defined in the appended claims and their equivalents.

What is claimed is:

1. An apparatus for positioning back-up pins on a support plate for supporting a circuit board thereon, the apparatus comprising:
a back-up pin plate having a substantially planar upper surface for positioning back-up pins thereon;
a back-up pin stand for placing back-up pins therein;
a camera for taking an image of a surface of the circuit board to be supported by a plurality of back-up pins;
a control unit configured to display at least one image of the circuit board taken by the camera, the image including a first image representative of a portion of the surface of the circuit board and a second image representative of substantially the entire surface of the circuit board, the control unit further configured to allocate a plurality of support locations for supporting the circuit board while viewing the first image and the second image of the circuit board; and
a transfer member adapted to transfer a plurality of back-up pins from the back-up pin stand to the allocated support locations on the back-up pin plate.

2. The apparatus of claim 1, wherein at least a portion of the back-up pin plate includes a magnetizable material, and each of the back-up pins includes a magnetic portion for attaching onto the back-up pin plate by a magnetic force between the back-up pin plate and the back-up pin.

3. The apparatus of claim 1, wherein the camera is a line charge-coupled device camera.

4. The apparatus of claim 1, wherein the first image is a real-time image taken by the camera and the second image is an image composed of a plurality of the real-time images taken by the camera.

5. The apparatus of claim 1, wherein the control unit includes a display screen for displaying the images of the circuit board taken by the camera.

6. The apparatus of claim 5, wherein the control unit further includes a user interface for allowing a user to control the allocation of the support locations and positioning of the back-up pins.

7. The apparatus of claim 6, wherein the control unit further includes an input device for the allocation of the support locations.

8. The apparatus of claim 7, wherein the input device of the control unit is a mouse configured to move a mouse pointer in the display screen displaying the image of the circuit board and select the support locations with the aid of the displayed screen.

9. The apparatus of claim 6, wherein the user interface comprises a back-up pin type selection menu.

10. The apparatus of claim 6, wherein the user interface comprises an insert mode for the allocation of the support locations.

11. The apparatus of claim 10, wherein the user interface further comprises a remove mode for cancellation of the previously allocated support locations.

12. The apparatus of claim 10, wherein the user interface comprises a save mode for saving the allocation information in the control unit.

13. The apparatus of claim 6, wherein the user interface comprises a PCB loading mode for loading a circuit board onto the apparatus.

14. The apparatus of claim 1, wherein the back-up pin stand comprises a plurality of openings for receiving lower portions of the back-up pins.

15. The apparatus of claim 1, wherein the camera is coupled with the transfer member for moving together along a Cartesian coordinate.

16. An apparatus for positioning back-up pins on a support plate for supporting a circuit board thereon, the apparatus comprising:
a plurality of back-up pins each having a magnet portion at least a lower portion thereof;
a back-up pin plate formed at least partially with a magnetizable material and including a substantially planar upper surface for positioning the back-up pins thereon; and
a transfer member adapted to transfer a plurality of back-up pins onto support locations on the back-up pin plate for supporting a circuit board thereon.

17. The apparatus of claim 16 further comprising a back-up pin stand for placing back-up pins therein.

18. The apparatus of claim 16 further comprising a camera for taking an image of a surface of the circuit board to be supported by a plurality of back-up pins.

19. The apparatus of claim 18, wherein the camera is coupled with the transfer member for moving together along a Cartesian coordinate.

20. The apparatus of claim 18 further comprising a control unit configured to display at least one image of the circuit board taken by the camera, the image including a first image representative of substantially the entire surface of the circuit board and a second image representative of a portion of the surface of the circuit board, the control unit further configured to allocate a plurality of support locations for supporting the circuit board while viewing the first image and the second image of the circuit board.

21. The apparatus of claim 16, wherein the back-up pins have a generally cylindrical shape with the upper portions of the back-up pins having different diameters.

22. The apparatus of claim 16, wherein the back-up pins each has a circumferential groove for providing a secure holding of the back-up pin by the transfer member.

23. The apparatus of claim 16, wherein the back-up pins each has a marking on its top surface thereof.

24. A back-up pin to be placed on a support plate for supporting a circuit board thereon in an electronic part mounting process, the back-up pin comprising:
a lower portion having a magnetic characteristic and including a planar lower surface; and
an upper portion including a planar upper surface for supporting a substrate thereon.

25. The back-up pin of claim 24, further comprising a circumferential groove along an intermediate portion thereof.

26. The back-up pin of claim 24 having a generally cylindrical shape.

27. The back-up pin of claim 26 having a diameter of about 8 mm at an upper end thereof.

28. The back-up pin of claim 26 having a diameter of about 2 mm at an upper end thereof.

29. A method of positioning back-up pins for supporting a substrate, the method comprising:
scanning an image of a surface of a substrate using a camera;
displaying a first image representative of a portion of the surface of the substrate and a second image representative of substantially the entire surface of the substrate on a monitor of a control unit;
allocating back-up pin support locations using the first and second images displayed on the monitor; and
transferring and positioning a plurality of back-up pins at the allocated locations on a back-up pin plate.

30. The method of claim 29 further comprising photographing of an image of back-up pins placed on a back-up pin stand prior to the transferring of the back-up pins.

31. The method of claim 29, wherein the first image is a real-time image taken by the camera, and the second image is an image composed of a plurality of the real-time images taken by the camera.

32. The method of claim 29, wherein the allocation of support locations is performed by selecting the locations by a mouse using the first and second images displayed on the monitor.

33. The method of claim 32, wherein the allocation of support locations is performed by selecting the locations by the mouse on the second image while viewing the first image to confirm the support locations are not interfered with any parts disposed on the substrate.

34. The method of claim 29, wherein the allocation enables selection of particular back-up pins from a plurality of back-up pins with different sizes or type.

35. The method of claim 29, wherein the scanning of the image of the substrate comprises scanning a marking formed on a top surface of the back-up pins to identify the type or dimension of the respective back-up pin.
